(19) United States
(12) Patent Application Publication
(10) Pub. No.: US 2006/0182664 A1
(43) Pub. Date: Aug. 17, 2006

(54) Flow cell devices, systems and methods of using the same

(76) Inventors: Bill J. Peck, Mountain View, CA (US); Eric M. Leproust, San Jose, CA (US); Lawrence J. DaQuino, Los Gatos, CA (US); Allen C. Thompson, Sunnyvale, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 11/058,012

(22) Filed: Feb. 14, 2005

(51) Int. Cl. B01L 3/00

(52) U.S. Cl. 422/102

(57) ABSTRACT

Flow cell devices and methods for using the devices are disclosed. In one aspect, the flow cell devices are used to expose substrate surfaces comprising biopolymers or monomers to a desired fluid. Workstations are also provided including a flow cell device and one or more station(s) for processing a substrate, such as one or more of a printer, reaction chamber, wash chamber, and scanner. Computer program products for implementing functions of the devices and workstations and for performing the methods are also disclosed.

### BACKGROUND

In the field of diagnostics and therapeutics, it is often useful to attach chemical species to a surface. One important application is in solid phase chemical synthesis wherein initial derivatization of a substrate surface enables synthesis of biopolymers such as oligonucleotides and peptides on the substrate itself. Some methods for modifying surfaces for use in chemical synthesis are described in U.S. Pat. No. 5,624,711, U.S. Pat. No. 5,266,222 and U.S. Pat. No. 5,137,765, for example.

Biopolymers synthesized on a solid support can be used as probes for target biomolecules in a sample. For example, arrays or ordered probes can be designed to define specific target sequences, analyze gene expression patterns, identify specific allelic variations, determine copy number of DNA sequences, and identify, on a genome-wide basis, binding sites for proteins (e.g., transcription factors and other regulatory molecules).

Biopolymer arrays can be created by in-situ synthesis, oligonucleotide deposition or cDNA. In one approach to the synthesis of microarrays, flow devices (e.g., flow cells) are employed in which a substrate is placed to carry out the synthesis. After the substrate is placed in the flow device, reagent is introduced into the device by an inlet. The reagent is held in the device for a predetermined period of time. Subsequently, the flow device is drained by opening an outlet valve and pressurizing the chamber with an inert gas to force out the liquid.

Design of current flow cells used for in situ synthesis generally does not consider management of flow, such Hele-Shaw flow, in the interior of the flow cell. Typically, the only design constraint is to ensure that bubbles are allowed to escape from the flow cell during filling and that the geometry of the cell is such that the reagent can be drained.

### SUMMARY OF THE INVENTION

In one embodiment, the invention relates to a flow cell device comprising: a flow cell chamber for receiving a substrate. In one aspect, an interior surface of the flow cell chamber comprises a plurality of inlet ports and a plurality of outlet ports. The device further comprises a bottom manifold in fluid communication with the chamber which comprises an entry conduit for providing a fluid to a first entry port of the chamber and an exit conduit for receiving fluid from a first exit port of the chamber, wherein the bottom manifold or a portion thereof (e.g., such as the entry conduit) comprises openings which communicate with or are coextensive with the inlet ports. In one aspect, the exit conduit comprises a means for controlling fluid flow through the bottom manifold, e.g., such as a valve or pump. In another aspect, flow of fluid through the exit port of the device is controllable to remove bubbles from, or prevent their formation in, the inlet ports.

In one embodiment, the flow cell device further comprises a base for aligning the flow cell chamber at least partially vertically during operation, such that the outlet ports are above the inlet ports relative to a surface on which the base rests.

In another embodiment, the flow cell device also comprises a top manifold in fluid communication with the chamber. In one aspect, the top manifold comprises an entry conduit for providing a fluid to a second entry port of the chamber and an exit conduit for receiving fluid from a second exit port of the chamber. In another aspect, the top manifold or a portion thereof (e.g., such as the entry conduit) comprises openings which communicate with or are coextensive with the outlet ports. In certain aspects, the top manifold can be used to vent the device while fluid flows into the chamber from the bottom manifold. In other aspects, the roles of the manifolds can be reversed, with the bottom manifold being used to vent the device while fluid flows into the chamber from the bottom manifold, e.g., such as when a lower density fluid is being introduced into the device.

The exit conduit of the top manifold also may comprise a means for controlling fluid flow through the top manifold, e.g., such as a valve or pump. Additionally, the entry conduits of the manifolds also may comprise valves for selectively controlling fluid flow through the manifold and through the flow chamber.

In still other embodiments, a plurality of top submanifolds can communicate with the chamber through a single top entry conduit. In one aspect, each of the plurality of top submanifolds communicates with a different dispensing line and each different dispensing line can communicate with one or more different dispensers. In certain aspects, fluid flow through each dispensing line is independently controlled by providing separate valves. In further embodiments, a plurality of bottom submanifolds also can communicate with the chamber through a single bottom entry conduit. In one aspect, each of the plurality of bottom submanifolds communicates with a different dispensing line and each different dispensing line can communicate with one or more different dispensers. In certain aspects, fluid flow through each dispensing line is independently controlled by providing separate valves. In still further aspects, a top submanifold can be coupled to a bottom submanifold via a dispensing line, but fluid flow to the bottom vs. top submanifold can be independently controlled by providing appropriately placed valves.

In another embodiment, the flow cell device comprises an opening for inserting one or more substrates into the chamber. In one aspect, the opening is sealable. In another embodiment, the device comprises two separable halves that can be separated for inserting one or more substrates and rejoined to seal the device.

In another embodiment, the invention relates to a system comprising a flow cell device, such as a device disclosed above, and further comprises one or more fluid and/or reagent sources for dispensing fluids and/or reagents into a manifold of the device (e.g., the top and/or bottom manifold). In one aspect, the system further comprises a processor for controlling the opening and closing of a manifold valve and/or for controlling delivery from the fluid and/or reagent sources to the chamber.

In another aspect, the system further comprises a vacuum source in fluid communication with the flow cell chamber. However, in a further aspect, the system does not include a vacuum source.

In still another aspect, the system further comprises a gas source connected to, or connectable to, a manifold of the system.

In a further aspect, the system comprises a plurality of flow cell devices.

In still a further aspect, the system further comprises one or more of: a station for monomer addition to the surface of a substrate, a station for performing a binding reaction between a reactant in a fluid and the substrate or molecules on the substrate, a station for exposing the substrate to a wash fluid, and a detector (e.g., such as a scanner) for detecting a reaction between a reactant in a fluid and the substrate or molecules on the substrate. In certain aspects, the system further comprises a mechanism for moving the substrate to and/or from a flow cell chamber and one or more of the stations. In one aspect, the station for performing the binding reaction is another flow cell chamber. In another aspect, the station for exposing the substrate to a wash fluid is another flow cell chamber. In a further aspect, the binding reaction is a hybridization reaction and the station comprises a mechanism for controlling the temperature of a fluid within a chamber of the station.

The invention further relates to a method for contacting a substrate with a fluid for a time interval, which can be predetermined. In one aspect, the method comprises placing a substrate in a flow cell chamber, the flow chamber comprising an interior surface comprising a plurality of inlet ports and a plurality of outlet ports, the outlet ports disposed vertically above the inlet ports. Fluid is introduced into a bottom manifold in fluid communication with the chamber and is provided to the chamber from the bottom manifold at a pressure sufficient to drive fluid from the manifold through inlet ports of the chamber. In one aspect, the method further comprises removing bubbles from the fluid provided by the bottom manifold to the chamber, i.e., preventing bubbles from clogging the inlet ports or from collecting at the inlet ports. In certain aspects, the manifold comprises an exit conduit that communicates with an exit port of the chamber, and bubbles are removed through the exit port. In one aspect, the flow of fluid through the exit port is controlled by selectively opening and/or closing a valve in the exit conduit.

In certain aspects, the method further comprises removing fluid from the chamber through the outlet ports of the chamber by simultaneously venting and applying a vacuum to said flow chamber. In one aspect, fluid from the outlet ports drains into a top manifold in fluid communication with the outlet ports. However, in a further aspect, a vacuum is not necessary to remove fluid from the chamber.

In one embodiment, the method further comprises displacing a first fluid in the flow cell chamber with a second fluid. The fluid can be a liquid or a gas.

In another embodiment, the fluid comprises a reactant for reacting with a molecule on a surface of the substrate. In one aspect, the reactant is a reactant that modifies the substrate or a molecule on the surface of the substrate for a chemical synthesis reaction. In certain aspects, the synthesis reaction is the synthesis of a biopolymer such as a nucleic acid or a polypeptide; for example, the reactant can be an oxidizing agent or an agent for removing a protecting group.

In one aspect, the substrate is contacted with a monomer prior to or after performing the synthesis reaction. In another aspect, the substrate is contacted with a plurality of monomers at discrete, addressable locations on the substrate to form an array of biopolymers. In certain aspects, the monomers are deposited on the substrate using a printer. In a further aspect, the substrate is moved from the printer to the flow cell chamber and from the flow cell chamber to the printer a plurality of times.

In another aspect, the reactant is a molecule, which binds to the substrate or to a molecule on the surface of the substrate. In one aspect, the method further comprises the step of detecting a reaction between the reactant and the substrate or a molecule on the substrate. In certain aspects, the same flow cell used for performing synthesis reaction(s) can be used for performing hybridization or binding reactions; however, different flow cell devices also can be used. The substrate can be placed in the flow cell as is or can be diced into smaller substrates. In other aspects, the same flow cell used for performing synthesis and/or hybridization or binding reactions can be used for washing the substrate.

In another embodiment, the invention relates to computer program products comprising instructions for performing methods according to aspects of the invention and/or for controlling functions of devices and/or systems described above.

### BRIEF DESCRIPTION OF THE DRAWINGS

The objects and features of the invention can be better understood with reference to the following detailed description and accompanying drawings. The Figures shown herein are not necessarily drawn to scale, with some components and features being exaggerated for clarity. Devices according to aspects of this invention are not required to conform to this literal depiction.

FIG. 1 is a schematic diagram depicting a flow cell assembly in accordance with one aspect of the invention.

FIG. 2 is a schematic diagram depicting a flow cell assembly in accordance with another aspect of the invention.

### DESCRIPTION OF THE INVENTION

Before describing the present invention in detail, it is to be understood that this invention is not limited to specific compositions, method steps, or equipment, as such may vary. It is also to be understood that the terminology used herein is for the purpose of describing particular embodiments only, and is not intended to be limiting. Methods recited herein may be carried out in any order of the recited events that is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

Unless defined otherwise below, all technical and scientific terms used herein have the same meaning as commonly understood by one of ordinary skill in the art to which this invention belongs. Still, certain elements are defined herein for the sake of clarity.

All publications mentioned herein are incorporated herein by reference to disclose and describe the methods and/or materials in connection with which the publications are cited.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

It must be noted that, as used in this specification and the appended claims, the singular forms “a”, “an” and “the” include plural referents unless the context clearly dictates otherwise. Thus, for example, reference to “a biopolymer” includes more than one biopolymer, and reference to “a voltage source” includes a plurality of voltage sources and the like.

Definitions

The following definitions are provided for specific terms that are used in the following written description.

The term “biomolecule” means any organic or biochemical molecule, group or species of interest that may be formed in an array on a substrate surface. Exemplary biomolecules include peptides, proteins, amino acids and nucleic acids.

The term “peptide” as used herein refers to any compound produced by amide formation between a carboxyl group of one amino acid and an amino group of another group.

The term “oligopeptide” as used herein refers to peptides with fewer than about 10 to 20 residues, i.e. amino acid monomeric units.

The term “polypeptide” as used herein refers to peptides with more than about 10 to about 20 residues.

The term “protein” as used herein refers to polypeptides of specific sequence of more than about 50 residue and includes D and L forms, modified forms, etc.

The terms “polypeptide”, “peptide” and “protein” may be used interchangeably unless context dictates otherwise.

The term “nucleic acid” as used herein means a polymer composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “nucleoside” and “nucleotide” are intended to include those moieties that contain not only the known purine and pyrimidine base moieties, but also other heterocyclic base moieties that have been modified. Such modifications include methylated purines or pyrimidines, acylated purines or pyrimidines, or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

The terms “ribonucleic acid” and “RNA” as used herein refer to a polymer composed of ribonucleotides.

The terms “deoxyribonucleic acid” and “DNA” as used herein mean a polymer composed of deoxyribonucleotides.

The term “oligonucleotide” as used herein denotes single stranded nucleotide multimers of from about 10 to 100 nucleotides and up to 200 nucleotides in length.

A “biopolymer” is a polymer of one or more types of repeating units. Biopolymers are typically found in biological systems (although they may be made synthetically) and may include peptides or polynucleotides, as well as such compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. For example, a “biopolymer” may include DNA (including cDNA), RNA, oligonucleotides, PNA, LNA, UNA and other polynucleotides, e.g., as described in U.S. Pat. No. 5,948,902 and references cited therein (all of which are incorporated herein by reference), regardless of the source.

The term “monomer” as used herein refers to a chemical entity that can be covalently linked to one or more other such entities to form a polymer. Of particular interest to the present application are nucleotide “monomers” that have first and second sites (e.g., 5′ and 3′ sites) suitable for binding to other like monomers by means of standard chemical reactions (e.g., nucleophilic substitution), and a diverse element which distinguishes a particular monomer from a different monomer of the same type (e.g., a nucleotide base, etc.). In the art synthesis of nucleic acids of this type utilizes an initial substrate-bound monomer that is generally used as a building-block in a multi-step synthesis procedure to form a complete nucleic acid. A “biomonomer” references a single unit, which can be linked with the same or other biomonomers to form a biopolymer (e.g., a single amino acid or nucleotide with two linking groups, one or both of which may have removable protecting groups). As used herein, the terms “monomer” and “biomonomer” are generally interchangeable.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other polynucleotides which are C-glycosides of a purine or pyrimidine base. In the practice of the instant invention, oligomers will generally comprise about 2-60 monomers, preferably about 10-60, more preferably about 50-60 monomers.

“Activator” refers to any suitable chemical and/or physical entity that is employed to make-possible, assist, enhance or increase in the joining or linking of a monomer to another chemical entity such as one or more other monomers or a reactive functional group such as a free hydroxy functional group present on a substrate surface, etc. For example, an activator may protonate a monomer so that it may be joined to another monomer or to a free functional group. For example, activators may be employed in phosphoramidite chemistry where they used in the joining of a deoxynucleoside phosphoramidite to a functional group present on a substrate surface or to another deoxynucleoside phosphoramidite. In producing nucleic acids on a substrate surface using phosphoramidite chemistry, one of the first steps in such a protocol involves attaching a first monomer to the substrate surface. Accordingly, a solution containing a protected deoxynucleoside phosphoramidite and an activator, such as tetrazole, benzoimidazolium triflate (“BZT”), S-ethyl tetrazole, and dicyanoimidazole, is applied to the surface of a substrate that has been chemically prepared to present reactive functional groups such as, for example, free hydroxyl groups. The activators tetrazole, BZT, S-ethyl tetrazole, and dicyanoimidazole are acids that protonate the amine nitrogen of the phosphoramidite group of the deoxynucleoside phosphoramidite. A free hydroxyl group on the surface of the substrate displaces the protonated secondary amine group of the phosphoramidite group by nucleophilic substitution and results in the protected deoxynucleoside covalently bound to the substrate via a phosphite triester group. An analogous methodology using an activator may be employed to link two deoxynucleoside phosphoramidites together such as a deoxynucleoside phosphoramidite to a substrate bound nucleotide. For example, a protected deoxynucleoside phosphoramidite in solution with an activator is applied to the substrate-bound nucleotide and reacts with the 5′ hydroxyl of the nucleotide to covalently link the protected deoxynucleoside to the 5′ end of the nucleotide via a phosphite triester group. In accordance with the subject invention, suitable “activators” include, but are not limited to, tetrazole and tetrazole derivatives such as S-ethyl tetrazole, dicyanoimidazole (“DCI”), benzimidazolium triflate (“BZT”), and the like. Activators are usually, though not always, present in a liquid, typically in solution, where such may be referred to as a “fluid activator”. In describing the subject invention, an activator includes an activator alone or with a suitable medium such as a fluid medium or the like. As such, an activator and a fluid activator may be used interchangeably herein.

The term “sample” as used herein relates to a material or mixture of materials, typically, although not necessarily, in fluid form, containing one or more components of interest.

The terms “nucleoside” and “nucleotide” are intended to include those moieties which contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

The terms “protection” and “deprotection” as used herein relate, respectively, to the addition and removal of chemical protecting groups using conventional materials and techniques within the skill of the art and/or described in the pertinent literature; for example, reference may be had to Greene et al., Protective Groups in Organic Synthesis, 2nd Ed., New York: John Wiley & Sons, 1991. Protecting groups prevent the site to which they are attached from participating in the chemical reaction to be carried out.

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present, and, thus, the description includes structures wherein a non-hydrogen substituent is present and structures wherein a non-hydrogen substituent is not present.

An “array layout” refers to one or more characteristics of the features, such as feature positioning on the substrate, one or more feature dimensions, and an indication of a moiety at a given location. “Hybridizing” and “binding”, with respect to polynucleotides, are used interchangeably.

The term “substrate” as used herein refers to a surface upon which marker molecules or probes, e.g., an array, may be adhered. Glass slides are the most common substrate for biochips, although fused silica, silicon, plastic and other materials are also suitable. Substrates can be substantially planar, or non-planar, e.g., in the form of beads, webs, and the like.

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly. “Stably attached” or “stably associated with” means an item's position remains substantially constant where in certain embodiments it may mean that an item's position remains substantially constant and known.

A “web” references a long continuous piece of substrate material having a length greater than a width. For example, the web length to width ratio may be at least 5/1, 10/1, 50/1, 100/1, 200/1, or 500/1, or even at least 1000/1.

The terms “hybridizing specifically to” and “specific hybridization” and “selectively hybridize to,” as used herein refer to the binding, duplexing, or hybridizing of a nucleic acid molecule preferentially to a particular nucleotide sequence under stringent conditions.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

“Stringent hybridization conditions” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions that set forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

“Contacting” means to bring or put together. As such, a first item is contacted with a second item when the two items are brought or put together, e.g., by touching them to each other.

“Depositing” means to position, place an item at a location—or otherwise cause an item to be so positioned or placed at a location. Depositing includes contacting one item with another. Depositing may be manual or automatic, e.g., “depositing” an item at a location may be accomplished by automated robotic devices.

By “remote location,” it is meant a location other than the location at which the array (or referenced item) is present and hybridization occurs (in the case of hybridization reactions). For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart.

“Communicating” information references transmitting the data representing that information as signals (e.g., electrical, radio or optical signals) over a suitable communication channel (e.g., a private or public network).

As used herein, a component of a system which is “in communication with” or “communicates with” another component of a system receives input from that component and/or provides an output to that component to implement a system function. A component which is “in communication with” or which “communicates with” another component may be, but is not necessarily, physically connected to the other component. For example, the component may communicate information to the other component and/or receive information from the other component. In other aspects, the component may communicate fluids to another component and/or receive fluids from the other component (either directly or through connecting structures (e.g., conduits, tubings, ports, and the like).

“Forwarding” an item refers to any means of getting that item from one location to the next, whether by physically transporting that item or otherwise (where that is possible) and includes, at least in the case of data, physically transporting a medium carrying the data or communicating the data.

An array “package” may be the array plus only a substrate on which the array is deposited, although the package may include other features (such as a housing with a chamber).

A “chamber” references an enclosed or enclosable volume (although a chamber may be accessible through one or more ports). It will also be appreciated that throughout the present application, that words such as “top,” “upper,” and “lower” are used in a relative sense only.

A “computer-based system” refers to the hardware means, software means, and data storage means used to analyze the information of the present invention. The minimum hardware of the computer-based systems of the present invention comprises a central processing unit (CPU), input means, output means, and data storage means. A skilled artisan can readily appreciate that many computer-based systems are available which are suitable for use in the present invention. The data storage means may comprise any manufacture comprising a recording of the present information as described above, or a memory access means that can access such a manufacture.

A “processor” references any hardware and/or software combination that will perform the functions required of it. For example, any processor herein may be a programmable digital microprocessor such as available in the form of an electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

“Computer readable medium” as used herein refers to any storage or transmission medium that participates in providing instructions and/or data to a computer for execution and/or processing. Examples of storage media include floppy disks, magnetic tape, UBS, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer. A file may be stored in permanent memory.

With respect to computer readable media, “permanent memory” refers to memory that is permanently stored on a data storage medium. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

A “memory” or “memory unit” refers to any device which can store information for subsequent retrieval by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

It will also be appreciated that throughout the present application, that words such as “cover”, “base” “front”, “back”, “top”, are used in a relative sense only. The word “above” used to describe the substrate and/or flow cell is meant with respect to the horizontal plane of the environment, e.g., the room, in which the substrate and/or flow cell is present, e.g., the ground or floor of such a room.

Flow Cell Devices

In one embodiment, the invention relates to a flow cell device for exposing one or more substrates to a substantially uniform fluid composition over a given time interval. In one aspect, the flow cell device comprises a housing defining a flow chamber. In another aspect, the flow chamber comprises an opening for receiving the one or more substrates or can comprise two halves, which can be brought into proximity to enclose a substrate and fluidly sealed. When the flow cell comprises an opening, the opening can be configured to be sealable after the array substrate is placed therein, to prevent the leakage of fluids from the flow cell through the opening. Such seals may include a flexible material that is sufficiently flexible or compressible to form a fluid tight seal that may be maintained under increased pressures encountered in the use of the device. The flexible member may be, for example, rubber, flexible plastic, flexible resins, and the like and combinations thereof. In one aspect, the flexible material is be substantially inert with respect to the fluids introduced into the device and does not interfere with the reactions that occur within the device. The flexible member may be a gasket and may be in any shape such as, for example, circular, oval, rectangular, and the like, e.g., the flexible member may be in the form of an O-ring in certain embodiments.

When the flow chamber comprises two halves, the halves may be stably associated by providing mating elements (e.g., a prong on one half that fits into an opening of another half). However, in another aspect, the two halves may be stably associated by claims or other pressure sealing mechanisms. In one aspect, the two halves are sealably engaged during reaction steps (e.g., synthesis steps) and are separable at other times to permit the support to be placed into and removed from the chamber of the flow cell. Movement of the one half with respect to the other may be achieved by means of, for example, pistons, and so forth. The movement may be controlled electronically by means that are conventional in the art.

The dimensions of the flow cell housing may vary and are dependent on the dimensions of a support that is to be placed therein. In certain embodiments, the array substrate may be one on which a single array of chemical compounds is synthesized. In this regard the substrate may range from about 1.5 to about 5 inches in length and about 0.5 to about 3 inches in width. The substrate may range from about 0.1 to about 5 mm, e.g., about 0.5 to about 2 mm, in thickness. A standard size microscope slide is usually about 3 inches in length and 1 inch in width and may be used. Alternatively, multiple arrays of chemical compounds may be synthesized on a given substrate or wafer, which may be used as is or which may then be diced, i.e., cut, into single array substrates in which each dices section may include one or more chemical arrays. In this alternative approach the substrate may range from about 5 to about 8 inches in length and about 5 to about 8 inches in width so that the substrate may be diced into multiple single array substrates having the aforementioned dimensions. The thickness of the substrate may be the same as that described above. In one embodiment by way of illustration and not limitation, a substrate that is about 65/8 inches by about 6 inches may be employed and diced into about 1 inch by about 3 inch substrates.

Flow cells that may be employed in certain embodiments may be about 6.5 inches wide by about 6 inches tall in the plane of the flow cell. More generally these dimensions may range from the size of an array about 1 cm square to about 1 meter square. The gap width in representative embodiments of flow cells that may be employed in the invention may range from about 1 μm to about 500 μm, and in certain embodiments may range from about 1-10 μm to about 10 mm.

Similarly, the volume containable by the flow cell can vary. In one aspect, the volume ranges from about 5 to about 50 ml, or from about 10 to about 25 ml, or about 20 ml.

In certain aspects, the flow cell device comprises an insulating member around at least a portion of the device.

In one aspect, the device exposes a substrate within the flow cell chamber to a flow of fluid, wherein a first end of the substrate and a second end of the substrate are exposed to a fluid comprising substantially the same composition at a given time interval. The flow cell can be used for performing in situ synthesis of biopolymers (e.g., nucleic acids or polypeptides) on the substrate.

In one embodiment, the flow cell comprises at least two inlet ports and at least two outlet ports. In one aspect, in operation, outlet port(s) sit vertically above inlet port(s). In another aspect, the flow cell comprises at least about 10, at least about 20, at least about 30 or at least about 40 inlet and outlet ports, respectively. In certain aspects, the number and position of inlet ports and outlet ports is varied to bias flow across different regions of the flow cell. However, in certain other aspects, the number of inlet ports and outlet ports is kept uniform to provide for an unbiased flow. In one aspect, inlet ports are uniformly spaced along the bottom of the flow cell chamber. In another aspect, the outlet ports are uniformly spaced along the top of the flow cell chamber.

In another embodiment, the flow cell chamber is at least partially vertical in operation to maintain the relative configuration of outlet and inlet ports described above. As used herein, “at least partially vertical” refers to an orientation in which a surface of the flow chamber comprising the inlet ports and outlet ports is placed is at an angle of greater than about 0°, greater than about 5°, greater than about 10°, greater than about 15°, including at least about 30°, e.g., at least about 45°, 60°, 75° and up to about 90° relative to a surface on which the flow cell device at least partially rests. In one aspect, the flow cell is oriented vertically (e.g., at a 90° angle) with respect to a surface on which the base of the flow cell (e.g., proximal to the inlet ports and bottom manifold) rests. In another aspect, the device comprises a stand for altering an angle of the surface of the flow chamber relative to the surface on which it rests, e.g., to an angle which is greater than 0°; in one aspect, the stand can alter the angle as the user desires from at least about 50 to at least about 90°.

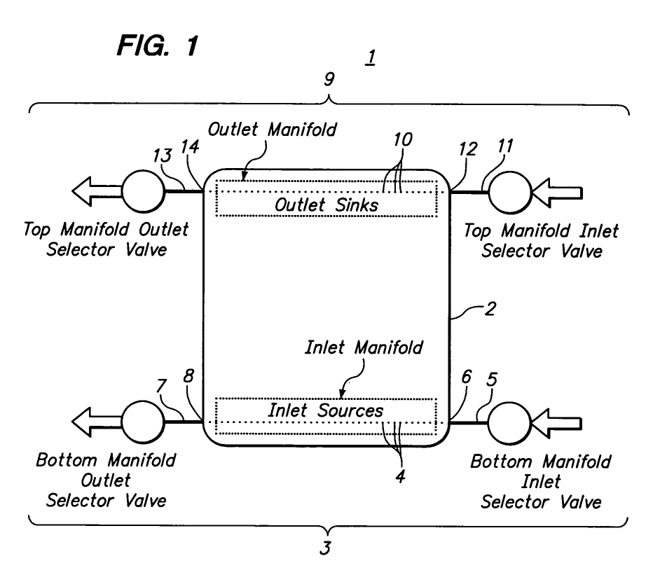

In one embodiment, as shown in FIG. 1, the invention relates to a flow cell assembly 1 that comprises a flow cell chamber 2 for receiving a substrate and a bottom manifold 3 in fluid communication with the chamber 2 for feeding fluid (e.g., a liquid and/or gas) into the flow chamber 2 via inlet ports 4. In one aspect, the bottom manifold 3 comprises an entry conduit 5 which communicates with a first end of the flow cell chamber via an entry port 6 and an exit conduit 7 which communicates with a second end of the flow cell via an exit port 8. The side of the bottom manifold 3 comprises openings that connect with or are coextensive with the inlet port 4 openings.

In operation, the bottom manifold is proximal to a surface on which the portion of the flow cell assembly 1 comprising the inlet ports 4 rests. Under suitable fluid flow conditions (e.g., when suitable pressure is applied to fluid in the bottom manifold), fluid entering into the bottom manifold 3 enters into the flow cell chamber 2 via the inlet port openings 4.

In one aspect, the device 1 further comprises or is connectable to a base station or platform to which fluid dispensing stations can be stably associated (e.g., by mounting). Any fluid dispensing station may be employed that dispenses fluids such as water, aqueous media, organic solvents, ionic liquids and the like. The fluid dispensing station may include a pump for moving fluid and may also comprise the bottom manifold and a valve assembly. In certain aspects, the assembly for includes a mechanism for delivering predetermined quantities of fluid to the flow cell. The fluids may be dispensed by pumping from the dispensing station. In this regard, any standard pumping technique for pumping fluids may be employed in the present apparatus. For example, pumping may be by means of a peristaltic pump, a pressurized fluid bed, a positive displacement pump, e.g., a syringe pump, and the like. In one embodiment, the device additionally comprises heating and/or cooling elements and/or insulating elements for controlling the temperature within various fluid reservoirs and/or in the flow chamber itself.

In one aspect, the bottom manifold connects or is connectable to (directly or indirectly) one or more fluid reagent dispensing stations. In this way, different fluid reagents can be contacted to a substrate in the flow cell chamber. In one aspect, reagents for performing different steps in the synthesis of a chemical compound (e.g., a nucleic acid or polypeptide) may be introduced sequentially into the flow cell.

In still other aspects, both the top and bottom manifold may connect to a the same one or more fluid reagent dispensing stations; however, fluid from the fluid dispensing stations to the top and bottom manifold can be independently controlled, e.g., through the use of automatically or manually operated valves.

In still another embodiment, the assembly 1 comprises a top manifold 9 that communicates with the portion of the flow cell chamber comprising the outlet ports 10. In one aspect, the top manifold 9 comprises an entry conduit 11 which communicates with a first end of the flow cell chamber 2 comprising the outlet ports 10 via an entry port 12 and an exit conduit 13 which communicates with a second end of the flow cell chamber 2 comprising the outlet ports 10 via an exit port 14. The side of the top manifold 9 comprises openings that connect with or are coextensive with the outlet port openings 10. When the device 1 is in operation, the top manifold 9 is distal to a surface on which the portion of the flow cell chamber comprising the inlet ports 4 is placed. The top manifold 9 also can be used to introduce or backfill fluid into a fully charged flow cell chamber 2. In certain aspects, the top manifold 9 connects, or is connectable to, one or more fluid dispensing stations.

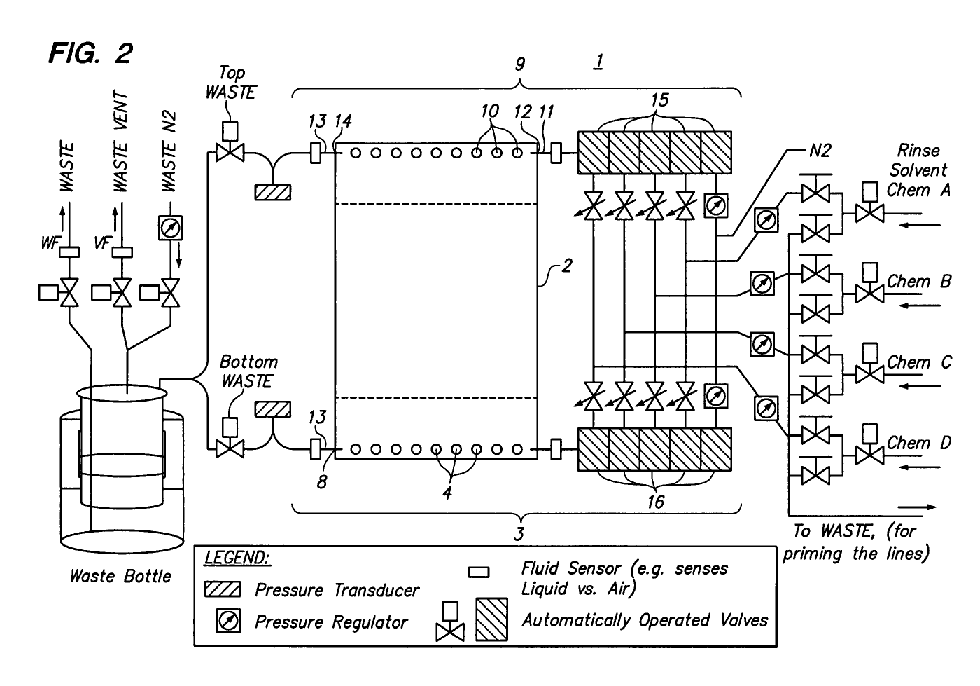

As shown in FIG. 2 and as discussed above, in certain further embodiments, the flow cell assembly comprises a plurality of top and bottom submanifolds 15, 16, fluid from which can enter into the flow cell chamber by a common top and bottom entry conduit respectively. In certain aspects, the plurality of top and bottom submanifolds are connected to one or more separate dispensing lines. In still other aspects, a top and bottom submanifold can be coupled via a common dispensing line, however fluid through the top or bottom manifold can be independently controlled by appropriately placed valves.

In one aspect, flow cell inlets comprise small diameter holes drilled into a common flow cell housing for receiving one or more substrates, e.g., in the range of about 0.15 mm to 2 mm. High pressure at the inlet ports equalizes pressure in the bottom manifold. In another aspect, the bottom manifold exit conduit provides a mechanism for removing bubbles, to reduce the presence of bubbles in the inlet port openings. In one aspect, the diameter of an exit port in the flow cell chamber which connects or is connectable to the exit conduit of the bottom manifold is larger than the opening diameter of the inlet ports e.g., at least about 1-fold larger, at least about 1.5-fold larger, at least about 2-fold larger or at least about 4-fold larger. In another aspect, flow through the inlet and/or outlet conduit of the feed manual is controlled by providing a valve whose opening and closing is controlled by a controller such as a micro-processor. Similarly, flow through the top manifold can be contolled by valve(s) provided in the entry conduit and the exit conduit of the top manifold.

In one aspect, the roles of the bottom manifold and top manifold are reversed, e.g., where it is advantageous to introduce a fresh reagent from the top of the flow cell (e.g., such as when the fresh reagent is less dense than the resident liquid). Thus, in one aspect, a valve can be shut in the top manifold to increase pressure in top manifold for introducing liquid into the flow cell through the outlets and the bottom manifold can be used to vent the device.

The flow cell assembly can further comprise a vacuum source in fluid communication with the chamber. In certain additional aspects, the flow cell assembly also comprises a fluid level sensor, one or more pressure transducers, one or more pressure regulators, manually or automatically operated valves and/or pumps.

In a further embodiment, the device can include mechanisms for facilitating movement of a substrate into and out of the flow chamber.

For example, in one aspect, the device comprises a lift mechanism for lowering the substrate into and lifting the substrate out of the housing chamber in a controlled manner, e.g., manually or in an automated fashion.

The flow cell assembly can also comprise a substrate transfer mechanism for moving a substrate from the flow cell chamber to another processing device (e.g., a sample introducing device, a substrate reaction device (e.g., for incubating a substrate with a reactant under reaction conditions), a washing device, a scanning device and combinations thereof. A substrate transfer mechanism also can be provided to move the substrate from a printing station to the flow cell chamber.

Transfer mechanisms can include robotic arms, and the like. In one embodiment, a transfer robot is mounted on a platform of an apparatus used in for synthesis. The transfer robot may include a base, an arm that is movably mounted on the base, and a grasping element adapted to grasp the substrate during transport that is attached to the arm. The element for grasping the substrate may be, for example, movable finger-like projections, and the like. In one aspect, in use, the robotic arm is activated so that the substrate is grasped by the grasping element. The arm of the robot is moved so that the substrate is delivered to the flow cell from a printing device.

Other componentry may be used to position the substrate, e.g., motors, pistons, conveyers, cranks, levers, etc., where such will be obvious to those of skill in the art in view of the disclosure. As noted above, in certain embodiments, a substrate may be positioned on a substrate holder or lift mechanism within the chamber of the flow cell. In such embodiments, the holder may be adapted to be moveable to position the substrate appropriately.

Methods

In one embodiment, the invention relates to methods for contacting a substrate with one or more fluids. The method can be used to expose the substrate to a reactant in the fluid. In one aspect, the substrate comprises one or more chemicals or molecules which for reacting with the reactant. The molecules can include, but are not limited to, polymers (e.g., peptides, proteins, nucleic acids or mimetics thereof, e.g. peptide nucleic acids, LNA, UNA molecules), polysaccharides, phospholipids, and the like, where the polymers may be hetero- or homopolymeric. In certain aspects, the substrate comprises cells or tissue sections stably immobilized thereto.

In one embodiment, the methods comprise using a flow cell according to the invention to expose a substrate to a reactant under conditions in which the substrate (and/or molecules, chemicals, cells, etc., attached thereto) can react thereto. In certain aspects, the reactant comprises a molecule for performing a synthesis reaction on the substrate (e.g., such as synthesis of a nucleic acid or polypeptide on the substrate). In other aspects, the reactant comprises a binding partner for a molecule on the substrate and in certain aspects, the method can further include detecting the reaction (e.g., binding of the reactant to a molecule on the substrate). In one aspect, a substrate is removed from the flow cell for the detection step.

In certain other aspects, the flow cell device is used to pretreat a substrate with a fluid prior to exposing it to a reactant. The exposing step may or may not occur within the flow cell.

In still other aspects, the flow cell device is used to wash a substrate that has been exposed to a fluid with or without a reactant with a wash fluid. Exposure to the reactant and/or fluid may or may not occur within the flow cell.

In one aspect, the flow cell is used to expose a substrate to a fluid which is a liquid.

In another aspect, the flow cell is used to expose a substrate to a fluid which is a gas (e.g., such as an inert gas).

In a further aspect, the flow cell is used to expose a substrate to a fluid, which comprises a mixture of a gas and a liquid. For example, in certain aspects, bubbles generated by pushing gas through the small ports could be used to scrub or remove debris from the surface of the substrate. In still other aspects, the flow cell chamber and/or manifolds can be coupled to a gas dispenser such as a N2 dispenser which can be used to purge a reagent or solvent solution passing through the flow cell and dry out the flow cell chamber and/or manifolds, prior to exposing the flow cell chamber and/or manifolds to new or additional solutions. In this way, carryover between reagents to which a substrate is exposed can be reduced.

In one embodiment, the method comprises placing the substrate in the flow cell chamber (e.g., manually or using an automated mechanism as discussed above), and introducing a fluid into the bottom manifold. In one aspect, the fluid initially introduced into the bottom manifold comprises a gas. In another aspect, the fluid comprises a mixture of a gas and liquid. The fluid is allowed to flow through the bottom manifold; initially fluid passes through the bottom manifold without entering into the flow cell chamber as there is insufficient pressure to drive fluid from the entry conduit into the inlet ports of the flow cell chamber. In one aspect, after most of the gas is removed from the manifold (e.g., as detected by a sensor), a valve in the manifold (e.g., at the exit conduit side of the manifold) is shut so that pressure builds up in the bottom manifold and fluid (e.g., a liquid) flows into the flow cell through the inlet ports. By providing a large exit port that communicates with the exit conduit, bubbles can be removed before they become lodged in any of the inlet ports. As discussed above, flow of fluid through the exit port can be controlled by means of a controller, which controls the opening and closing of a valve in the exit conduit.

In one embodiment, a first liquid phase in the flow cell chamber is displaced with a next fluid phase. The valve in the exit conduit of the bottom manifold is opened, allowing a second fluid phase to be introduced from the bottom manifold (e.g., supplied to it from an appropriate fluid dispenser connected to the bottom manifold). The valve can again be closed to allow pressure to build up within the bottom manifold and fluid to be introduced into the flow cell chamber through the inlet ports. The displaced first fluid phase exits through the outlet ports, e.g., through the exit ports and exit conduit which communicate with the top manifold. In certain aspects, the top manifold or top portion of the flow cell chamber communicates with one or more dispensers for receiving waste fluids. In certain aspects, the bottom manifold or bottom portion of the flow cell chamber communicates with one or more dispensers for receiving waste fluids. The dispensers can be configured as waste lines that feed into, e.g., a waste bottle. In certain aspects, a waste line extends from both the top and bottom portion of the flow cell chamber. One or both waste lines can be coupled to pressure transducers and/or fluid sensors and controlled by independently through the use of valves, for example. In one aspect, both waste lines join to form a common waste line which feeds into a waste bottle. The waste bottle can be coupled to waste vents.

In certain embodiments, the first and second fluids are liquids. However, in other embodiments, the first and second fluids are gases. In still other embodiment, the first and second fluids are liquid and glasses, respectively, such that a first liquid is displaced by a second gas, or a first gas is displaced by a second liquid.

In one embodiment, the invention relates to methods of synthesizing biopolymers on the surface of a substrate. In one aspect, the methods comprise methods for synthesizing nucleic acid arrays by in situ synthesis of two or more distinct nucleic acids on the surface of a solid support or substrate. In one embodiment, the in situ synthesis protocol employed in the subject invention can be viewed as an iterative process that includes two or more cycles, where each cycle includes: a monomer attachment step in which a blocked nucleoside monomer is covalently bonded to two or more distinct locations, e.g., at least a first and second location, of a functional group, e.g., hydroxyl, amino, etc., displaying surface of a solid support; and an internucleotide linkage stabilization and 5′ functional group generation step in which the phosphite triester linkage is oxidized and functional groups are generated at the blocked ends of the resultant attached blocked nucleotides by removal of the blocking groups for addition of subsequent nucleoside monomers.

In certain embodiments of interest, each cycle includes the following steps: a monomer attachment step in which a 5′OH blocked nucleoside monomer is covalently bonded to two or more distinct locations, e.g., at least a first and second location, of a hydroxyl functional group displaying surface of a solid support, e.g., a nascent planar surface of a solid support displaying hydroxyl functional groups or a surface displaying intermediate nucleic acids having 5′OH groups; and an internucleotide linkage stabilization and 5′OH generation step in which the phosphite triester linkage is oxidized and hydroxyl groups are generated at the 5′ ends of the resultant attached blocked nucleotides by removal of the blocking groups for addition of subsequent nucleoside monomers, where this step includes oxidizing and deblocking substeps, as well as optionally a capping substep. Each of these cycle steps is now described separately in greater detail in terms of these particular embodiments. However, the scope of the invention is not so limited—the invention being described in terms of these particular representative embodiments for ease of description only.

In the monomer attachment step of each cycle, one or more different 5′OH blocked nucleoside monomers is contacted with one or more different locations of a substrate surface that displays hydroxyl functional groups, such that the nucleoside monomers become covalently bound to the surface, e.g., via a nucleophilic substitution reaction between the an activated (e.g., protonated) phosphoramidite moiety of the blocked nucleoside monomer and the surface displayed hydroxyl functionality. The surface displayed hydroxyl functionality may be on the surface of a nascent substrate, or may be at the 5′ end of a growing nucleic acid, depending on the particular point in the synthesis protocol. For example, at the beginning of a particular synthesis protocol, the surface displayed hydroxyl functional groups are immediately on the surface of a solid support or substrate. In contrast, following one or more cycles of a given synthesis protocol, the surface displayed functional groups are present at the 5′ ends of growing nucleic acids which, in turn, are covalently bonded to the surface of the solid support.

As such, at the beginning of any array synthesis protocol, the first step is to provide a substrate having a surface that displays hydroxyl functional groups, where the hydroxyl functional groups are employed in the covalent attachment of the growing nucleic acid ligands to the substrate surface during synthesis. The substrate may be any convenient substrate that finds use in biopolymeric arrays. In general, the substrate may be rigid or flexible. The substrates may be fabricated from a variety of materials. In certain embodiments, e.g., where one is interested in the production of nucleic acid arrays for use in research and related applications, the materials from which the substrate may be fabricated may exhibit a low level of non-specific binding during hybridization events. In many situations, it is of interest to employ a material that is transparent to visible and/or UV light. Specific materials of interest include: silicon; glass; plastics, e.g., polytetrafluoroethylene, polypropylene, polystyrene, polycarbonate, and blends thereof, and the like; metals, e.g. gold, platinum, and the like; etc. The surface may be modified with one or more different layers of compounds that serve to modify the properties of the surface in a desirable manner. Such modification layers, when present, will generally range in thickness from a monomolecular thickness to about 1 mm, usually from a monomolecular thickness to about 0.1 mm and more usually from a monomolecular thickness to about 0.001 mm. Modification layers of interest include: inorganic and organic layers such as metals, metal oxides, conformal silica or glass coatings, polymers, small organic molecules and the like. Polymeric layers of interest include layers of: peptides, proteins, polynucleic acids or mimetics thereof, e.g. peptide nucleic acids and the like; polysaccharides, phospholipids, polyurethanes, polyesters, polycarbonates, polyureas, polyamides, polyethyleneamines, polyarylene sulfides, polysiloxanes, polyimides, polyacetates, and the like, where the polymers may be hetero- or homopolymeric, and may or may not have separate functional moieties attached thereto, e.g. conjugated. The particular surface chemistry will be dictated by the specific process to be used in polymer synthesis, as described in greater detail infra. However, as mentioned above, the substrate that is initially employed has a surface that displays hydroxyl functional groups.

As mentioned above, nucleic acid arrays are produced according to the subject invention by synthesizing nucleic acid polymers using conventional phosphoramidite solid phase nucleic acid synthesis chemistry where the solid support is a substrate as described above. Phosphoramidite based chemical synthesis of nucleic acids is well known to those of skill in the art, being reviewed above and in U.S. Pat. No. 4,415,732, the disclosure of the latter being herein incorporated by reference.

To produce nucleic acid arrays according to the subject methods, a substrate surface as described above having the appropriate surface groups, e.g., —OH groups, present on its surface, is obtained. In one embodiment, the synthesis protocol is carried out under anhydrous conditions, and reactions are carried out in a non-aqueous, typically organic solvent layer on the substrate surface, where the solvent layer is acetonitrile in certain embodiments.

Next, the first residues of each nucleic acid to be synthesized on the array are covalently attached to the substrate surface via reaction with the surface bound —OH groups. Depending on whether the first nucleotide residue of each nucleic acid to be synthesized on the array is the same or different, different protocols for this step may be followed. Where each of the nucleic acids to be synthesized on the substrate surface have the same initial nucleotide at the 3′ end, the entire surface of the substrate is contacted with the blocked, activated nucleoside under conditions sufficient for coupling of the activated nucleoside to the reactive groups, e.g. —OH groups, present on the substrate surface to occur. In these embodiments, the entire surface of the array may be contacted with the fluid composition containing the activated nucleoside using any convenient protocol, such as flooding the surface of the substrate with the activated nucleoside solution, immersing the substrate in the solution of activated nucleoside, etc. The fluid composition is typically a fluid composition of the blocked nucleoside in an organic solvent, e.g., acetonitrile, where the fluid composition typically includes an activating agent, e.g., tetrazole, benzoimidazolium triflate (“BZT”), S-ethyl tetrazole, and dicyanoimidazole, etc. Such steps can be performed within a flow cell according to the invention.

Alternatively, where the initial residue of the various nucleic acids differs among the nucleic acids, one or more sites on the substrate surface are individually contacted with fluid compositions of the appropriate blocked, activated nucleoside. In this latter embodiment, any convenient protocol for selectively contacting a particular site, region or cell of a substrate surface with a fluid composition of the activated nucleoside may be employed. Of particular interest in many embodiments is the use of pulse-jet deposition protocols, such as those described in U.S. Pat. Nos. 6,171,797; 6,180,351; 6,232,072; 6,242,266; 6,300,137; and 6,323,043; as well as U.S. patent application Ser. No. 09/302,898 filed Apr. 30, 1999; the disclosures of which documents, particularly with respect to their teaching of in situ array synthesis via pulse-jet deposition protocols, are herein incorporated by reference. In these embodiments, two or more different fluid compositions of activated, blocked nucleosides, which fluid compositions differ from each other in terms of the activated nucleoside present therein, are each pulse-jetted onto one or more distinct locations of the surface, where the locations are dictated by the sequence of the desired nucleic acid at each location.

The activated nucleoside monomers employed in this attachment step of each cycle of the subject synthesis methods are blocked at their 5′-OH functionalities (ends) with an acid labile blocking group. By acid labile blocking group is meant that the group is cleaved in the presence of an acid to yield a 5′-OH functionality. In many embodiments, the acid labile blocking group is DMT, as described above.

The above step of the subject protocols results in a “blocked monomer attached substrate” where the surface is characterized by the presence of blocked monomers, e.g., DMT blocked nucleoside monomers, covalently attached to the surface of a solid support, either directly if the blocked monomers are the first residues of to be synthesized surface bound nucleic acid ligands, or through a growing nucleic acid ligands, i.e., where blocked monomers are at the end of growing nucleic acid chains. This resultant “blocked monomer attached substrate” is then subjected to the next step of the subject synthesis cycle, i.e., the 5′OH generation step.

As summarized above, following covalent attachment of activated, blocked nucleoside monomers to one or more locations of the substrate surface, functional, e.g., 5′OH hydroxyl, moieties are then generated on the surface so that the synthesis cycle can be repeated with a new round of activated, blocked nucleoside monomers. This generation step includes (in representative embodiments) the following substeps: (a) oxidation; (b) optional capping; and (c) deblocking. These steps can be conducted within flow cells according to aspects of the invention.

A feature of the subject methods is that each of these substeps is accomplished by contacting the entire surface of the substrate with an appropriate fluid, i.e., an oxidation fluid, a capping fluid or a deblocking fluid, a wash fluid, etc. Contact of the entire surface is achieved in the subject methods by flooding the surface with the appropriate fluid, using a flow cell as disclosed herein, such that the entire substrate is contacted with a volume of the appropriate liquid, e.g., by flowing a volume of the appropriate liquid over the surface of the substrate through the bottom manifold. As such, in representative embodiments, performance of each substep includes flowing an adequate volume of the appropriate fluid over the substrate surface so that the entire surface of the substrate is contacted with the fluid.

In certain embodiments, wash reagent is first allowed to pass into and out of the flow cell. Next, oxidizing agent is introduced into the flow cell. Following an additional wash step, the support is then subjected to a deblocking step. In this step, a deblocking reagent for removing a protecting group is flooded over the substrate surface. Next, wash fluid contained in a fluid dispensing station that is in fluid communication with the flow cell may be flooded over the substrate. Optionally, the substrate surface may be contacted with a capping fluid that includes a capping agent, where the surface may be contacted with a capping fluid at one or more times, e.g., prior to oxidation, prior to deblocking, etc. Following the above steps, the support may be transported from the flow cell to the printing chamber where the next monomer addition is carried out and the above repetitive synthetic steps are conducted as discussed above.

The amount of the reagents employed in each of the above steps in the method of the present invention is dependent on the nature of the reagents, solubility of the reagents, reactivity of the reagents, availability of the reagents, purity of the reagents, and so forth. Such amounts should be readily apparent to those skilled in the art in view of the disclosure herein. Usually, stoichiometric amounts are employed, but excess of one reagent over the other may be used where circumstances dictate. Typically, the amounts of the reagents are those necessary to achieve the overall synthesis of the chemical compound in accordance with the present invention. The time period for conducting the present method is dependent upon the specific reaction and reagents being utilized and the chemical compound being synthesized.

In view of the above, the functional group generation step may be viewed as a process in which the substrate surface is sequentially contacted or flooded with a plurality of two or more different fluids, for example three or more fluids, including four or more fluids, such as oxidizing fluid, wash fluid, deblocking fluid, and optionally capping fluid.

In one aspect, the substrate surface is not exposed to or contacted with a triple phase interface line. As such, the substrate surface (at least that which is to be occupied by the polymeric features in the final array product) is not simultaneously contacted with a gas and liquid. In representative embodiments, the substrate surface is not contacted with a gas during the functional group generation step. In other words, the substrate surface is not subjected to a triple interface phase line of gas, solid and liquid. To prevent exposure of the substrate surface to a gas, in representative embodiments of the subject methods, excess fluid or solution employed in a given substep is removed from the substrate surface prior to performing the next substep by purging or displacing the fluid from the surface with the immediately subsequent fluid in the series of fluids that is to be contacted with the surface. In other words, in sequentially contacting the surface with the plurality of fluids, any given previous fluid in the sequential plurality of fluids is removed from the surface by displacing that fluid with the immediately subsequent fluid. For example, where a given 5′ functional group generation step requires sequential contact of a surface with the following liquids in the following order: (1) cap liquid; (2) wash liquid; (3) oxidizing liquid; (4) cap liquid; (5) wash liquid; (6) deblock liquid; (7) wash liquid; each prior liquid in the sequence of liquids is displaced or purged from the surface with the immediately following liquid, such that the first cap liquid is purged by the wash liquid; the second wash liquid is purged by the oxidizing liquid; the third oxidizing liquid is purged by the cap liquid; the fourth cap liquid is purged by the fifth wash liquid; the fifth wash liquid is purged by the sixth deblock liquid; and the sixth deblock liquid is purged by the seventh wash liquid. For convenience, an immediately subsequent liquid that is employed to purge the prior liquid from the surface is referred to in the following paragraphs as the “purging fluid or liquid.”

In certain embodiments, the preceding or prior fluid is displaced from the surface by flowing the purging fluid across the surface in a manner that produces a defined or stratified interface or front between the purging fluid and the preceding fluid, which defined interface is maintained as it moves across the substrate surface and the prior fluid is concomitantly displaced therefrom. This technique uses pressure gradient driven flow. In embodiments of the subject invention, the pressure gradient is brought about by gravity through orientation of the flow cell at least partially vertically.

The rate at which the purging fluid is flowed across the surface of the substrate to displace the preceding or prior fluid of the sequence is chosen to maintain a substantially stratified front or interface between the purging and prior fluids as the front progresses across the substrate. As such, the flow rate of the purging fluid is selected so as to achieve minimal mixing of the purging and preceding fluids as the preceding fluid is displaced or purged from the substrate surface. The chosen rate at which the purging fluid is flowed across the surface of the substrate in the flow cell may be based on consideration of the following principles of fluid flow through a flow cell. As is known by those of skill in the art, the characteristics of fluid flow within a flow cell are determined by the Reynolds number (Re), where Re=ρ (density)*U(velocity of fluid flow)*gapwidth/viscosity. The Re for the flow cells employed in certain embodiments of the subject invention is or about o(100) and is strictly laminar, even in the presence of unstable density fronts. As such, consideration may be given to the characteristics of the laminar flow with respect to the boundary layer of material that remains close to the substrate as the purging fluid is introduced into the flow cell. As the purging fluid passes over the substrate surface, a thin layer of the prior fluid will be left on the substrate surface that must be diffused from the surface into the bulk flow of the purging fluid. As is known to those of skill in the art, the characteristics of this flow are determined by the Peclet number (Pe) where Pe=U*b/D where U is the centerline speed, b is the gap width and D is the molecular diffusivity of the active deblocking agent in the wash solvent. For very high Pe the convective bulk flow dominates and there is little time for material to diffuse into the bulk flow, which can be undesirable in the present invention. At low Pe, molecular diffusion allows the purging fluid and prior fluid to interpenetrate via diffusion thus allowing the surface to be substantially cleansed of prior fluid (e.g., by the mechanism known to those of skill in the art as the Taylor dispersion). In representative embodiments, the rate at which the purging fluid is flowed across the substrate surface may range from about 1 cm/s to about 20 cm/s.

As indicated above, the purging fluid is, in representative embodiments, a fluid of different density relative to the prior fluid that is being displaced or purged. A measure of the density difference is given by the Atwood number (A) which is equal to (ρ1−ρ2)/(ρ1+ρ2), where ρ1 is the density of the fluid on the bottom and ρ2 is the density of the fluid superposed on top of the lower fluid. In representative embodiments, the purging fluid is chosen such that the density difference (A) between the purging fluid and the prior fluid or solution that is being displaced is greater than 0, and in certain embodiments ranges from about 0.001 to about 0.5, including from about 0.01 to about 0.2.

As summarized above, the above 5′ functional group generation step is performed using a flow cell in certain embodiments. Accordingly, for example, after addition of a nucleoside monomer, such as depositing the reagent using a pulse-jet method, the substrate is placed into the chamber of a flow cell according to the invention. The flow cell allows fluids to be passed through the chamber where the support is disposed. The support may be mounted in the chamber in or on a holder. In one approach, fluids may be introduced into the chamber by means of the inlet ports with the outlet ports serving as vents and fluids may be removed from the chamber by means of the outlet ports with the inlet ports serving as vents. Outlet ports and inlet ports can be different sizes or the same size. As such, all of the fluids in the plurality of fluids contacted with the surface are contacted with the surface in a “first-in-first-out” manner. However, in one aspect, a first end of the substrate (e.g., proximal to the inlet ports) and a second end of the substrate (e.g., proximal to the outlet ports) are contacted with a substantially uniform fluid composition at a given time interval (e.g., prior to purging a fluid phase in the chamber).

As discussed above, the inlets of the flow cell are in fluid communication with an element that controls the flow of fluid into the flow cell such as, e.g., the bottom manifold, which in turn is in fluid communication with one or more fluid reagent dispensing stations. In this way different fluid reagents for one step in the synthesis of the chemical compound may be introduced sequentially into the flow cell. These reagents may be, for example, wash fluids, oxidizing agents, reducing agents, blocking or protecting agents, unblocking (deblocking) or deprotecting agents, and so forth, as indicated above and described in greater detail below. Any reagent that is normally a solid reagent may be converted to a fluid reagent by dissolution in a suitable solvent, which may be a protic solvent or an aprotic solvent. The solvent may be an aqueous medium that is solely water or may contain a buffer, or may contain from about 0.01 to about 80 or more volume percent of a cosolvent such as an organic solvent as mentioned above. The solvent may, in certain embodiments, be an ionic liquid.

Following the 5′-generation step, summarized above, the remaining fluid, e.g., wash fluid, may be removed from the surface, e.g., by draining, and the surface dried.

In performing the above-described substeps, while the order of oxidation and blocking may be reversed, the deblocking step is typically performed following capping/oxidation. As such, the capping/oxidation steps are described together first, followed by a description of the deblocking step. It should be noted that capping before oxidation also prevents formation of branched DNA, while capping after oxidation also removes moisture introduced by the oxidation. In some protocols, capping is done before and after oxidation. As such, capping may be performed before oxidation, after oxidation, or both before and after oxidation.

It should be noted that the following descriptions of deblocking, oxidizing, capping and wash fluids are merely representative, and that other types of fluids may be employed in a given protocol, e.g., a combined oxidizing/deblocking fluid, such as that described in Published United States Application No. 20020058802, the disclosure of which is herein incorporated by reference in its entirety.

Oxidation results in the conversion of phosphite triesters present on the substrate surface following coupling to phosphotriesters. Oxidation is accomplished by contacting the surface with an oxidizing solution, as described above, which solution includes a suitable oxidizing agent. Various oxidizing agents may be employed, where representative oxidizing agents include, but are not limited to: organic peroxides, oxaziridines, iodine, sulfur etc. The oxidizing agent is typically present in a fluid solvent, where the fluid solvent may include one or more cosolvents, where the solvent components may be organic solvents, aqueous solvents, ionic liquids, etc. A representative oxidizing agent of interest is I₂/H₂O/Pyridine/THF. Following contact of the surface with the oxidizing solution, excess is removed as described above.

In addition, unreacted hydroxyl groups may be (though not necessarily) capped, e.g., using any convenient capping agent, as is known in the art. This optional capping is accomplished by contacting the surface with an capping solution, as described above, which solution includes a suitable capping agent, such as a solution of acetic anhydride, pyridine or 2,6-lutidine (2,6-dimethylpyridine), and tetrahydrofuran (“THF”); a solution of 1-methyl-imidazole in THF; etc. Following contact of the surface with the oxidizing solution, excess oxidizing solution is removed as described above.

The next substep is the deblocking step, where acid labile protecting groups present at the 5′ ends of the growing nucleic acid molecules on the substrate are removed to provide free 5′ OH moieties, e.g., for attachment of subsequent monomers, etc. In this deblocking step (which may also be referred to as a deprotecting step as results in removal of the protecting blocking groups), the entire substrate surface is contacted with a deblocking or deprotecting agent, typically in a flow cell, as described above. The substrate surface is incubated for a sufficient period of time under appropriate conditions for all available protecting groups to be cleaved from the nucleotides that they are protecting.

In some embodiments, the deblocking solution includes an acid present in an organic solvent that has a low vapor pressure. The vapor pressure of the organic solvent that is employed in the deblocking solution is typically at least substantially the same as toluene, by which is meant that the vapor pressure is not more than about 350% and usually not more than about 150% of the vapor pressure of toluene at a given set of temperature/pressure conditions. In certain embodiments, the organic solvent is one that has a vapor pressure that is less than about 13 KPa, usually less than about 8 KPa and more usually less than about 5 KPa at standard temperature and pressure conditions i.e., STP conditions (0° C.; 1 ATM). A variety of organic solvents are of interest, where such solvents include, but are not limited to: toluene, xylene (o, m, p), ethylbenzene, perfluoro-n-heptane, perfluoro decalin, chlorobenzene, 1,2 dichloroethane, 1,1,2 trichloroethane, 1,1,2,2 tetrachloroethane, pentachloroethane, and the like; where in many embodiments, the organic solvent that is employed is toluene. The acid deblocking agent employed in the deblocking solution may vary, where representative acids of interest include, but are not limited to: acetic acids, e.g., acetic acid, mono acetic acid, dichloroacetic acid, trichloroacetic acid, monofluoroacetic acid, difluoroacetic acid, trifluoroacetic acid, and the like. The amount of acid in the solution is sufficient to remove blocking groups, and typically ranges between about 0.1 and 20%, more typically ranges between 1 and 3%, as is known in the art.

Contact of the substrate surface with a deblocking solution results in removal of the protecting groups from the blocked substrate bound residues. As such, this step results in the deprotection of the nucleotide residues on the substrate surface. Following deprotection, the deblocking solution is removed from the surface of the substrate.

Removal of the deblocking agent according to the subject methods results in a substrate surface in which the nucleotide residues are deprotected. In others words, removal of the deblocking agent results in the production of an array of nucleotide residues stably associated with the substrate surface, where the nucleotide residues on the array surface have 5′-OH groups available for reaction with an activated nucleotide in subsequent cycles.

In certain embodiments, the surface of the substrate is washed between one or more of the above described capping, oxidation and deblocking steps. Any convenient wash fluid may be employed in these one or more wash steps. In certain embodiments, the wash fluid may be a low viscosity fluid. In these embodiments, the viscosity of the wash fluid typically does not exceed about 1.2, and in certain embodiments does not exceed about 0.6, such as about 0.4 cP (as measured at 25° C.). The non-dimensional capillary number of the flow should be in the range of from about 10⁻² to about 10⁻⁶. The capillary number Ca is defined as Ca=(μ×U)σ, where μ is the viscosity, U is the linear speed and σ is the surface tension. This number provides a range within which the substrate or wafer drag-out speed can be adjusted to account for the particular fluid properties. However, while Ca serves as a coarse guide for controlling mechanical aspects of the flow, other subtleties such as the evaporation rate and fluid adherence to the substrate manifested in the disjoining pressure influence the motion of the contact line. Such embodiments are employed where it is desired for the any liquid film remaining on the surface of the substrate following fluid removal to evaporate rapidly.

In certain embodiments, the wash fluid is an organic solvent or an ionic liquid. In certain embodiments, solvents of from 1 to about 6, more usually from 1 to about 4, carbon atoms, including alcohols such as methanol, ethanol, propanol, etc., ethers such as tetrahydrofuran, ethyl ether, propyl ether, etc., acetonitrile, dimethylformamide, dimethylsulfoxide, and the like, may be employed. Specific organic solvents of interest include, but are not limited to: acetonitrile, acetone, methanol, ethanol and the like.

The above steps of: (a) monomer attachment; and (b) functional group regeneration, e.g., 5′OH hydroxyl regeneration, are repeated a number of times with additional monomers, e.g., nucleotides until each of the desired polymers, e.g., nucleic acids on the substrate surface are produced. By choosing which sites are contacted with which activated nucleotides, e.g. A, G, C & T, an array having polymers of desired sequence and spatial location is readily achieved.

As such, the above cycles of monomer attachment and functional (e.g., hydroxyl) moiety regeneration result in the production of an array of desired polymers, e.g., nucleic acids. The resultant arrays can be employed in a variety of different applications, as described in greater detail below.

The above method steps may be carried out manually using flow cell devices according to the invention or in workstations including such devices, as described further below. In one aspect, the invention relates to an automated system that can automatically transfer a substrate from an activated monomer deposition location, i.e., a “writer station” to the flow cell device where the above steps of capping, oxidation and deblocking are carried out, e.g., a wet chemical processing station in which the substrate surface is automatically contacted with the appropriate fluids in a sequential fashion.

As indicated above, the above description describing use of 5′OH functional groups, acid labile blocking groups, such as DMT and the use of an acid deblocking agent, are merely representative. Various modifications may be made and still fall within the scope of the invention. For example, other functional groups may be employed, e.g., amine functional groups. In yet other embodiments, base labile blocking groups may be employed, where such groups and the use thereof are described in U.S. Pat. No. 6,222,030; the dislcosure of which is herein incorporated by reference. In these latter types of embodiments, the acid deblocking agent described above is replaced with a base deblocking agent. In yet other embodiments, the “direction” of synthesis may be reversed, such that the synthesized nucleic acids are attached to the substrate at their 5′ ends and one generates 3′ functional groups in the deblocking/deprotecting step.

The subject invention has been described above in terms of fabrication of nucleic acids arrays. While the above description has been provided in terms of nucleic acid array production protocols for ease and clarity of description, the scope of the invention is not so limited, but instead extends to the fabrication of any type of array structure, particularly biopolymeric array structure, including, but not limited to polypeptide arrays, in addition to the above described nucleic acid arrays. For example, the subject methods and devices can be useful for the fabrication of arrays using a protocol that includes a deblocking step, such as the representative deblocking step described above, where a blocking group is removed at some point during an iterative synthesis process.

The present methods and devices, for example, may be used in the synthesis of polypeptides. The synthesis of polypeptides involves the sequential addition of amino acids to a growing peptide chain. One approach includes attaching an amino acid to the functionalized surface of a substrate. In one aspect, the synthesis involves sequential addition of carboxyl-protected amino acids to a growing peptide chain with each additional amino acid in the sequence similarly protected and coupled to the terminal amino acid of the oligopeptide under conditions suitable for forming an amide linkage. Such conditions are well known to the skilled artisan. See, for example, Merrifield, B. (1986), Solid Phase Synthesis, Sciences 232, 341-347. After polypeptide synthesis is complete, acid is used to remove the remaining terminal protecting groups. In accordance with embodiments of the present invention each of certain repetitive steps involved in the addition of an amino acid may be carried out in a flow cell. Such repetitive steps may involve, among others, washing of the surface, protection and deprotection of certain functionalities on the surface, oxidation or reduction of functionalities on the surface, and so forth.

In certain aspects, biopolymers can be synthesized at known locations on the substrate to form an array of biopolymers. An “array,” or “chemical array” used interchangeably includes any one-dimensional, two-dimensional or substantially two-dimensional (as well as a three-dimensional) arrangement of addressable regions bearing a particular chemical moiety or moieties (such as ligands, e.g., biopolymers such as polynucleotide or oligonucleotide sequences (nucleic acids), polypeptides (e.g., proteins), carbohydrates, lipids, etc.) associated with that region. In the broadest sense, the arrays of many embodiments are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes, the arrays are arrays of polypeptides, e.g., proteins or fragments thereof.

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, light directed synthesis fabrication processes are used. It will be appreciated though, that the interfeature areas, when present, could be of various sizes and configurations.

Each array may cover an area of less than 100 cm², or even less than 50 cm², 10 cm² or 1 cm². In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays may be fabricated using drop deposition from pulse jets of either polynucleotide precursor units (such as monomers) in the case of in situ fabrication, or the previously obtained polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein.

An array substrate may carry one, two, four or more arrays disposed on a front surface of the substrate and depending on the use of the array, any or all of the arrays may be the same or different from one another and each may contain multiple spots or features. The one or more arrays can cover only a portion of a substrate surface. In one aspect, a surface of a substrate does not carry any arrays. Each array can be designed for testing against any type of sample, whether a trial sample, reference sample, a combination of them, or a known mixture of biopolymers such as polynucleotides. A substrate may be of any shape, as mentioned above.

As mentioned above, an array contains multiple spots or features of biopolymers, e.g., in the form of polynucleotides. As mentioned above, all of the features may be different, or some or all could be the same. The interfeature areas can be of various sizes and configurations. In one aspect, each feature carries a predetermined biopolymer such as a predetermined polynucleotide (which includes the possibility of mixtures of polynucleotides). It will be understood that there may be a linker molecule linking the biopolymer to the substrate surface.

In one aspect, a substrate surface carries an identification code, e.g., in the form of a bar code or the like. For example, an identifier can be printed on the substrate in the form of a paper label attached by adhesive or any convenient means. The identification code contains information relating to array, where such information may include, but is not limited to, an identification of array, i.e., layout information relating to the array(s), etc.

In those embodiments where an array includes two more features immobilized on the same surface of a solid support, the array may be referred to as addressable. An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “probe” may be the one which is to be evaluated by the other (thus, either one could be an unknown mixture of analytes, e.g., polynucleotides, to be evaluated by binding with the other).

Substrates used in methods according to aspects of the invention can comprise a variety of materials and shapes and can include composite materials. The support to which a plurality of chemical compounds is attached is usually a porous or non-porous water insoluble material. The support can have any one of a number of shapes, such as strip, plate, disk, rod, particle, and the like. The support can be hydrophilic or capable of being rendered hydrophilic or it may be hydrophobic. The support is usually glass such as flat glass whose surface has been chemically activated to support binding or synthesis thereon, glass available as Bioglass and the like. However, the support may be made from materials such as inorganic powders, e.g., silica, magnesium sulfate, and alumina; natural polymeric materials, particularly cellulosic materials and materials derived from cellulose, such as fiber containing papers, e.g., filter paper, chromatographic paper, etc.; synthetic or modified naturally occurring polymers, such as nitrocellulose, cellulose acetate, poly (vinyl chloride), polyacrylamide, cross linked dextran, agarose, polyacrylate, polyethylene, polypropylene, poly(4-methylbutene), polystyrene, polymethacrylate, poly(ethylene terephthalate), nylon, poly(vinyl butyrate), etc.; either used by themselves or in conjunction with other materials; ceramics, metals, and the like. In one aspect, e.g., for packaged arrays, the support is a non-porous material such as glass, plastic, metal and the like.

Workstations Comprising Flow Cells

In one embodiment, the invention relates to a system or workstation comprising a flow cell assembly and a mechanism for moving a substrate into and out of the flow cell. In one aspect, the workstation further comprises one or more of a printer, a hybridization chamber, a wash chamber, and a scanner. In certain aspects, the functions of the hybridization chamber and/or wash chamber may be combined in the flow cell chamber. For example, the flow cell chamber can be modified to regulate temperatures and conditions of a fluid in the flow cell chamber to promote reaction between a reactant in a fluid and molecules on the substrate.

In one aspect, the system comprises robotic arms and/or conveyers for transporting a substrate to and from a flow cell device according to the invention to one or more of a printer, a hybridization chamber, a wash chamber, and a scanner. In another aspect, the system comprises a platform on which the components of the system are mounted. In a further aspect, the system further comprises a computer with which various components of the system are in communication. In one aspect, a video display is provided which is in communication with the computer. As discussed above, the system also can include various transfer mechanisms (e.g., robotic arms, conveyers and the like), which can be subject to the control of the computer. In another aspect, various functions of the flow cell are controlled by the computer according to a program of instructions which can control the timing of valve operations, fluid flow through manifolds, pressure of fluid in the manifolds, venting and the like. Similarly, various functions of other system devices can be controlled by the computer according to a program of instructions. In certain aspects, the functions of various system devices are coordinately controlled to enable high throughput movement of substrates from one system device to another system device.

In one aspect, a system of the invention further includes appropriate electrical and mechanical architecture and electrical connections, wiring and devices such as timers, clocks, and so forth for operating the various elements of the system. Such architecture is familiar to those skilled in the art and will not be discussed in more detail herein.

Similarly, the methods in accordance with the present invention may be carried out under computer control, that is, with the aid of a computer. (As used herein, the term “computer” is used interchangeably with the term “processor.”) For example, an IBM® compatible personal computer (PC) may be utilized. The computer may be driven by software specific to the methods described herein. Computer hardware capable of assisting in the operation of the methods in accordance with the present invention involves, in certain embodiments, a system with at least the following specifications: Pentium® processor or better with a clock speed of at least 100 MHz, at least 32 megabytes of random access memory (RAM) and at least 80 megabytes of virtual memory, running under either the Windows 95 or Windows NT 4.0 operating system (or successor thereof). Software that may be used to carry out the methods may be, for example, Microsoft Excel or Microsoft Access, suitably extended via user-written functions and templates, and linked when necessary to stand-alone programs. Examples of software or hardware programs used in assisting in conducting the present methods may be written, preferably, in Visual BASIC, FORTRAN and C++. It should be understood that the above computer information and the software used herein are by way of example and not limitation. The present methods may be adapted to other computers and software. Other languages that may be used include, for example, PASCAL, PERL or assembly language.

A system computer may be pre-programmed, e.g., provided to a user already programmed for performing certain functions, or may be programmed by a user, where a processor may be programmed, e.g., by a user, from a remote location meaning a location other than the location at which the computer and/or flow cell device is present. For example, a remote location could be another location (e.g. office, lab, etc.) in the same city, another location in a different city, another location in a different state, another location in a different country, etc. A computer may be remotely programmed by “communicating” programming information to the computer, i.e., transmitting the data representing that information as electrical signals over a suitable communication channel (for example, a private or public network). “Forwarding” programming refers to any means of getting that programming from one location to the next, whether by physically transporting that programming or otherwise (where that is possible) and includes, physically transporting a medium carrying the programming or communicating the programming. Any convenient telecommunications means may be employed for transmitting the programming, e.g., facsimile, modem, Internet, LAN, WAN or other network means, etc.

In a further embodiment, the invention relates to a computer program utilized to carry out the above method steps/system/flow cell operations. In one aspect, the computer program provides for controlling the valves of the flow cell assembly to introduce reagents into the flow cell, vent the flow cell, and so forth. The computer program further may provide for moving the substrate to and from the flow cell chamber—e.g., to a printer for monomer addition at a predetermined point in the aforementioned method.

All publications, including patents, patent applications, and literature references, cited herein are incorporated herein in their entirety by reference and for all purposes to the same extent as if each individual publication was specifically and individually indicated to be incorporated by reference in its entirety for all purposes.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A flow cell device comprising:
a flow cell chamber for receiving a substrate, wherein an interior surface of the flow cell chamber comprises a plurality of inlet ports and a plurality of outlet ports; and
a bottom manifold in fluid communication with the chamber, the bottom manifold comprising an entry conduit for providing a fluid to a first entry port of the chamber and an exit conduit for receiving fluid from a first exit port of the chamber, wherein the bottom manifold or a portion thereof comprises openings which communicate with or are coextensive with the inlet ports.

2. The flow cell device of claim 1, wherein the exit conduit comprises a valve which controls fluid flow through the bottom manifold.

3. The flow cell device of claim 1, further comprising a base for aligning the flow cell chamber at least partially vertically during operation, such that the outlet ports are above the inlet ports relative to a surface on which the base rests.

4. The flow cell device of claim 1, wherein flow through the exit port is controllable to remove bubbles from, or prevent their formation in, the inlet ports.

5. The flow cell device of claim 1, wherein the diameter of exit port is about 1-fold larger than an inlet port.

6. The flow cell device of claim 1, wherein the device further comprises a top manifold in fluid communication with the chamber, the top manifold comprising an entry conduit for providing a fluid to an second entry port of the chamber and an exit conduit for receiving fluid from a second exit port of the chamber, wherein the top manifold or a portion thereof comprises openings which communicate with or are coextensive with the outlet ports.

7. The flow cell device of claim 6, wherein the exit conduit of the top manifold comprises a valve for controlling fluid flow through the top manifold.

8. The flow cell device of claim 1, wherein the entry conduit of the bottom manifold comprises a valve for regulating fluid flow through the chamber.

9. The flow cell device of claim 6, wherein the entry conduit of the bottom manifold comprises a means for regulating fluid flow through the chamber.

10. The flow cell device of claim 1, wherein the device comprises an opening for inserting one or more substrates into the chamber.

11. The flow cell device of claim 10, wherein the opening is sealable.

12. The flow cell device of claim 1, wherein the device comprises two separable halves that can be separated for inserting one or more substrates and rejoined to seal the device.

13. A system comprising a flow cell device of claim 1, further comprising one or more fluid and/or reagent sources for dispensing fluids and/or reagents into a manifold of the device.

14. The system of claim 13, wherein the system further comprises a processor for controlling the opening and closing of a manifold valve and/or for controlling delivery from the fluid and/or reagent sources to the chamber.

15. The system of claim 13, further comprising a vacuum source in fluid communication with the flow cell chamber.

16. The system of claim 13, further comprising a gas source connected to or connectable to a manifold of the system.

17. The system of claim 13, further comprising a plurality of flow cell devices.

18. The system of claim 13, further comprising one or more of: a station for monomer addition to the surface of a substrate, a station for performing a binding reaction between a reactant in a fluid and the substrate or molecules on the substrate, a station for exposing the substrate to a wash fluid, and a detector for detecting a reaction between a reactant in a fluid and the substrate or molecules on the substrate.

19. The system of claim 18, further comprising a mechanism for moving the substrate to and/or from a flow cell chamber and one or more of the stations.

20. The system of claim 18 where the station for performing the binding reaction is another flow cell chamber.

21. The system of claim 18, wherein the station for exposing the substrate to a wash fluid is another flow cell chamber.

22. The system of claim 18, wherein the binding reaction is a hybridization reaction and the station comprises a mechanism for controlling the temperature of a fluid within a chamber of the station.

23. A method for contacting a substrate with a fluid comprising:
placing a substrate in a flow cell chamber, the flow chamber comprising an interior surface comprising a plurality of inlet ports and a plurality of outlet ports, the outlet ports disposed vertically above the inlet ports,
introducing a fluid into a bottom manifold in fluid communication with the chamber;
providing the fluid to the chamber from the bottom manifold at a pressure sufficient to drive fluid from the manifold through inlet ports of the chamber;
removing bubbles in the fluid provided by the bottom manifold to the chamber.

24. The method of claim 23, wherein the manifold comprises an exit conduit that communicates with an exit port of the chamber, and bubbles are removed through the exit port.

25. The method of claim 24, wherein flow of fluid through the exit port is controlled by selectively opening and closing a valve in the exit conduit.

26. The method of claim 23, further comprising removing fluid from the chamber through the outlet ports of the chamber by simultaneously venting and applying a vacuum to said flow chamber.

27. The method of claim 26, wherein fluid from the outlet ports is provided to a top manifold in fluid communication with the outlet ports.

28. The method of claim 26, further comprising displacing a first fluid in the chamber with a second fluid.

29. The method of claim 23, wherein the fluid is a liquid or a gas.

30. The method of claim 23, wherein the fluid comprises a reactant for reacting with a molecule on a surface of the substrate.

31. The method of claim 23, wherein the reactant is a reactant that modifies the substrate or a molecule on the surface of the substrate for a chemical synthesis reaction.

32. The method of claim 31, wherein the synthesis reaction is the synthesis of a biopolymer.

33. The method of claim 32, wherein the biopolymer comprises a nucleic acid.

34. The method of claim 32, wherein the biopolymer comprises a polypeptide.

35. The method of claim 23, wherein the reactant is a molecule which binds to the substrate or to a molecule on the surface of the substrate.

36. The method of claim 35, wherein the method further comprises the step of detecting a reaction between the reactant and the substrate or a molecule on the substrate.

37. The method of claim 32, wherein the substrate is contacted with a monomer prior to or after performing the synthesis reaction.

38. The method of claim 37, wherein the substrate is contacted with a plurality of monomers at discrete, addressable locations on the substrate to form an array of biopolymers.

39. The method of claim 38, wherein the monomers are deposited on the substrate using a printer.

40. The method of claim 39, wherein the substrate is moved from printer to the flow cell chamber and from the flow cell chamber to the printer a plurality of times.

41. The method of claim 23, wherein fluid is removed from the chamber by venting and applying a vacuum at opposite ends of the flow chamber.

42. The method of claim 23, wherein fluid is removed by venting at the outlet end of the chamber and applying a vacuum at the inlet end of the chamber.

43. The method of claim 23, wherein fluid is removed from the chamber by venting at the inlet end of the chamber and applying a vacuum at the outlet end of the chamber.

44. The method of claim 23, further comprising holding a fluid within the flow chamber for a predetermined period of time.

45. The method of claim 31, wherein the reactant is an oxidizing agent or an agent for removing a protecting group.

46. The method of claim 23, wherein the substrate is diced into smaller substrates.

47. A computer program product comprising instructions for controlling the opening and closing of a manifold valve and/or for controlling delivery from the fluid and/or reagent sources to the chamber of a device according to claim 1.
